(19) United States
(12) Patent Application Publication
(10) Pub. No.: US 2007/0010365 A1
(43) Pub. Date: Jan. 11, 2007

(54) PLANET CARRIER FOR A PLANETARY DRIVE

(75) Inventor: GUNTER SCHMITT, HAUSEN (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, HERZOGENAURACH (DE)

(21) Appl. No.: 11/428,667

(22) Filed: Jul. 5, 2006

(30) Foreign Application Priority Data
Jul. 6, 2005 (DE) 102005031592.5

(51) Int. Cl. F16H 57/04

(52) U.S. Cl. 475/159

(57) ABSTRACT

A planet carrier (1) for a planetary drive is provided, especially for a motor vehicle transmission, which has a disk-shaped section (2), over whose periphery a number of planet gears (3) are supported, wherein means (4) are present in order to supply the area of the planet gears (3) and/or their bearings (5) with lubricant. To improve the supply of lubricant to the planet gears or the bearing, according to the invention the means (4) have at least one lubricant channel (7) extending radially on one side (6) of the disk-shaped section (2).

### FIELD OF THE INVENTION

The invention relates to planet carrier for a planetary drive, especially for a motor vehicle transmission, which has a disk-shaped section, over whose periphery a number of planet gears (pinions) are supported, with there being means to supply the area of the planet gears and/or their bearings with lubricant.

### BACKGROUND OF THE INVENTION

Planetary drives, as used, for example, in automatic passenger car transmissions, have a number of planet gears held by a planet carrier. The planet gears mesh with a central sun wheel, as well as with a ring gear arranged concentric to the sun wheel. So the planet gears and also the bearings, with which they are held on the planet carrier, can be sufficiently supplied with lubricant, especially oil, various solutions are known in the state of the art.

From DE 43 02 844 C1 and DE 44 18 693 C1, a planet carrier arrangement is known, which has an oil baffle disk fixed to a side wall component of the planet carrier in an area radially outside the planet gear shaft.

A lubricant supply for a planetary gear drive for feeding the lubricant by means of centrifugal force is known from DE 199 60 157 A1. To improve the lubricant supply, guide devices, which also have a channel leading through a wall, are provided here for the lubricant.

Additional solutions, with which the lubricant supply to the point to be lubricated is to be improved, or general configurations of a planet carrier are known from DE 197 18 030 A1, from U.S. Pat. No. 3,131,582, from U.S. Pat. No. 2,968,190, and from EP 0 274 874 B1.

What is common in all of the known solutions is that the lubricating oil is collected by disks. The oil collects on the disk and then flows via longitudinal and transverse bores to the point to be lubricated, namely to the planet gears or to their needle ring bearings.

Here, it is a disadvantage that in the case of inclined oil bores, only very little oil is fed to the point to be lubricated. The already small amount of oil collected on the oil baffle disks, if necessary, must still overcome the components disrupting the oil flow, before it reaches the point to be lubricated, which leads to low oil flow at the relevant point. Only when sufficient oil has collected is there an oil flow to the planet gear or to its bearing, which usually consists of a needle bearing. With inadequate lubrication, there is relatively high wear on the planetary drive.

### SUMMARY

The present invention is based on the objective of improving a planet carrier of the type named above, so that the above disadvantages are prevented. Thus, it should lead to a sufficient oil flow to the points to be lubricated in the area of the teeth of the planetary drive. In particular, the oil supply to the planet gears and their bearings should be improved.

The solution to meeting this objective provided by the invention is provided in that the means for supplying lubricant, especially lubricating oil, have at least one lubricant channel running radially on one side of the disk-shaped section.

Preferably, the lubricant channel is in fluid connection with another channel section, which expands over a given extent in the axial direction of the planet carrier and is provided there with an outlet for lubricant.

In this way, a line for lubricating oil is created, which extends from a radially inner area of the planet carrier up to the radially farther outwardly spaced planet gears. Here, the lubricating oil is deflected from an initially radially outwardly pointing flow direction into an axial direction and feeds the point to be supplied in a targeted manner.

A refinement of the invention provides that the disk-shaped section and the one or more lubricant channels are manufactured separately and then connected to each other. The disk-shaped section preferably is formed of metal, especially sheet metal, while the lubricant channel can be manufactured from plastic, wherein it can be produced through injection molding. Here, it is preferred that the disk-shaped section and the one or more lubricant channels are connected to each other by at least one catch or clip connection. After the separate production of the disk-shaped section and the lubricant channels, this arrangement enables both parts to be assembled through a clip connection in a simple way. For this purpose, projections or extensions can be injection molded on the lubricant channels. On one end, these extensions have hooks, which can engage in corresponding recesses in the disk-shaped section in order to create a tight connection between the two parts. In order to integrate the lubricant channels into the disk-shaped section favorably, the disk-shaped section can have at least one recess corresponding to the contact surface of the lubricant channels on the disk-shaped section.

Preferably, the lubricant channel is formed as a channel with an essentially rectangular cross section, wherein the other channel section can be formed as an essentially cylindrical channel. The lubricant channel can taper slightly conically outwards in the radial direction. The other channel section can extend concentric to the axle of a planet gear. Here, it can be provided that the oil outlet of the other channel section opens into a bore, especially into a blind bore, of an axle carrying the planet gear via the bearing. In the case of a blind hole, it is provided that the axle has at least one transverse bore, by means of which the oil can flow to the point to be lubricated. Here, the one or more lubricant channels are arranged preferably on the side of the disk-shaped section opposite the side, on which the axle is arranged.

The bearing of the planet gear is usually formed as a needle ring.

It can be further provided that a reinforcement element extending in the axial direction connects to the disk-shaped section of the planet carrier in its radially outer area. The reinforcement element can be formed as a ring element. This can have a number of breaks over its periphery, wherein the number of breaks can correspond to the number of planet gears carried by the planet carrier. Here, the planet carrier is formed as a pot-shaped component and preferably manufactured in shaping methods, especially through deep drawing.

The planet carrier is usually carried by a shaft, which is formed as a hollow shaft and which has radial bores for the passage of lubricant. Here, a radial bore can be adjacent to the oil inlet of a lubricant channel. Furthermore, in this case it is provided that there is an axial bearing, which is lubricated at the same time in this way, between the radial bore and the inlet of a lubricant channel.

In general, the invention can be used in all planetary drives. Preferably, it is used in automatic transmissions in motor vehicles, especially in passenger cars.

### BRIEF DESCRIPTION OF THE DRAWINGS

A preferred embodiment of the invention is shown in the drawings. Shown are:

FIG. 1 is a perspective view of three planet gears of a planetary drive, which mesh with a sun wheel;

FIG. 2 is a top perspective view of the base of a planet carrier with disk-shaped section and reinforcement elements;

FIG. 3 is a the view corresponding to FIG. 2, but from a viewing direction from below;

FIG. 4 is a perspective view showing the means for supplying lubricant, prior to mounting on the planet carrier in a perspective view;

FIG. 5 is a top perspective view of the base of the planet carrier according to FIG. 2 with mounted means for supplying lubricant;

FIG. 6 is a view corresponding to FIG. 5 but from a viewing direction from below;

FIG. 7 is a view according to FIG. 6, but now with installed planet gears meshing with the sun wheel;

FIG. 8 is a radial section view through the planet carrier including planet gears and sun wheel;

FIG. 9 is a view corresponding to FIG. 8 with registered oil flow, and

FIG. 10 is a perspective view of a cut-out of the lubricant channel with a partially cut-away planet gear.

### DETAILED DESCRIPTION OF THE PREFERRED EMBODIMENTS

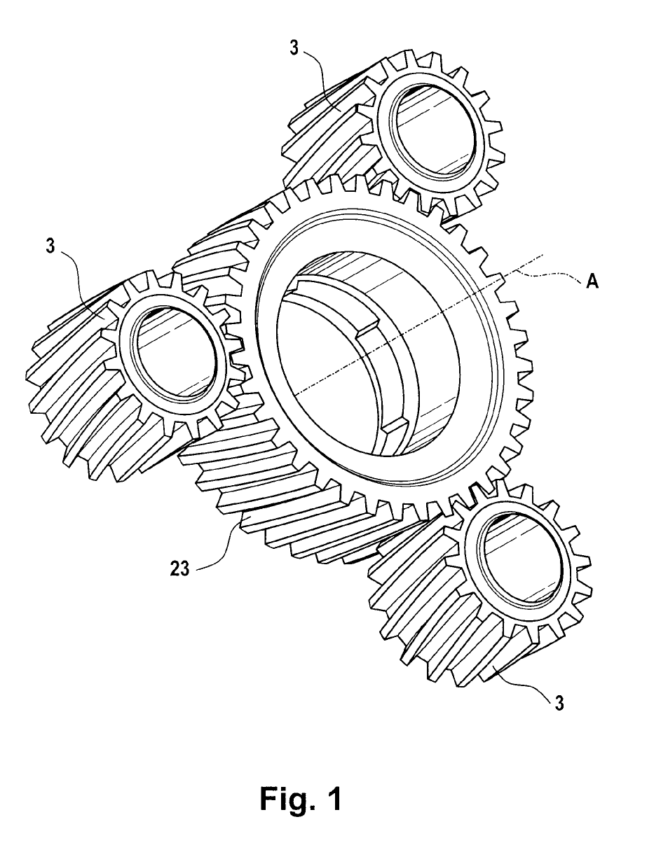

FIG. 1 shows schematically which gears are to be supported and lubricated with the present invention. Shown are three planet gears 3, which are formed as helical spur pinions and which mesh with a central sun wheel 23. The sun wheel 23 rotates about the central axis, indicated with A. Not shown is the hollow ring gear, with which the planet gears 3 mesh and which is essential for the function of the planetary drive.

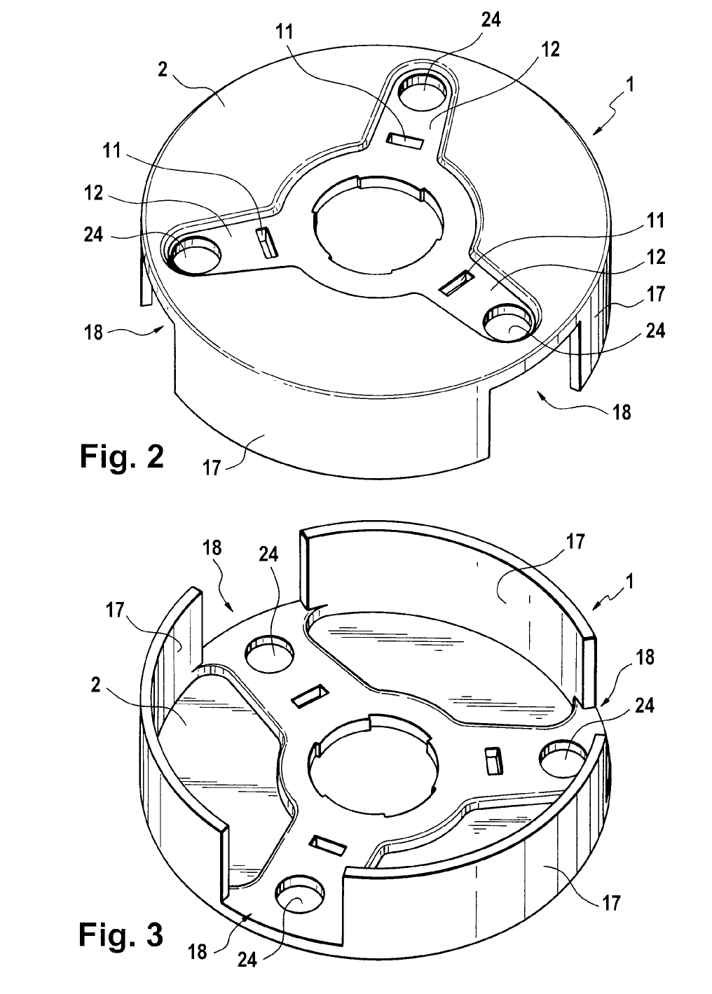

The planet carrier 1, which is to be seen in FIGS. 2 and 3, is used for supporting and guiding the planet gears 3. It is formed as a pot-shaped component, which is formed of sheet metal and is manufactured through shaping (deep drawing). The planet carrier 1 has a disk-shaped section 2, on whose radially outer edge, a reinforcement element 17 extends in the axial direction. The carrier 1 further has impressed or deep-drawn recesses 12, which correspond to the shape of lubricant channels 7 described below in more detail. Here, there are also three stamped bores 24, through which—as is seen later—another channel section 8 can pass the means 4 for supplying lubricant.

The circular edge, i.e., the reinforcement element 17, has three breaks 18, which create the free space for the later assembly of the planet gears 3. In this case there are three planet gears 3, which are arranged equidistant around the periphery of the planet carrier 1. In exactly the same manner, a higher number of planet gears is also possible.

Still to be pointed out are slit-shaped recesses 11, which are components of a catch or clip connection, with which the lubricant channel 7 can be fastened on the disk-shaped section 2.

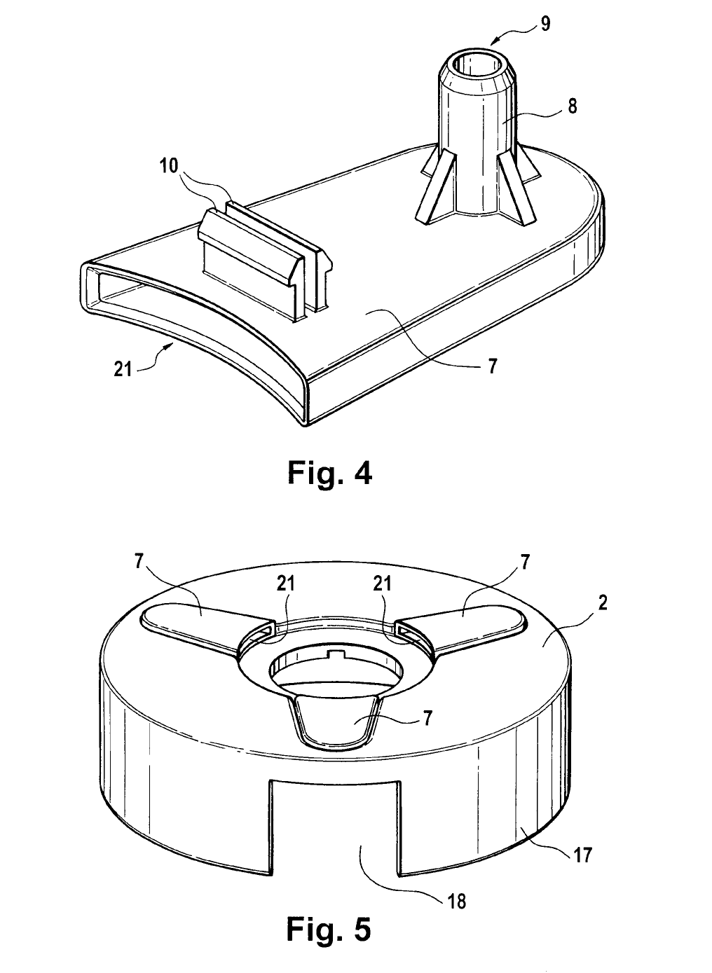

The injection-molded lubricant channel 7 made from plastic is shown in FIG. 4. It has an inlet 21, through which oil can then flow into the interior of the lubricant channel 7. The cross section through the lubricant channel 7 is rectangular. Another channel section 8, which is formed as a hollow cylinder and which ends with an outlet 9 for the oil, is spaced at a distance to the inlet 21. There is a fluid connection, i.e., the oil entering into the inlet 21 emerges again at the outlet 9, between the inlet 21 and the outlet 9.

Two hook-shaped elements 10, which are components of a catch or clip connection, are injection-molded on the surface of the lubricant channel 7. The shape of the hook-shaped elements 10 corresponds to that of the slit-shaped recesses 11 in the disk-shaped section 2, so that a locking connection can be realized after the elements 10 have been pressed into the slit-shaped recess 11, with which the lubricant channel 7 can be connected to the disk-shaped section 2. Here, the other hollow cylindrical channel section 8 then projects through the bores 24 (see FIGS. 2 and 3) in the disk-shaped section 2.

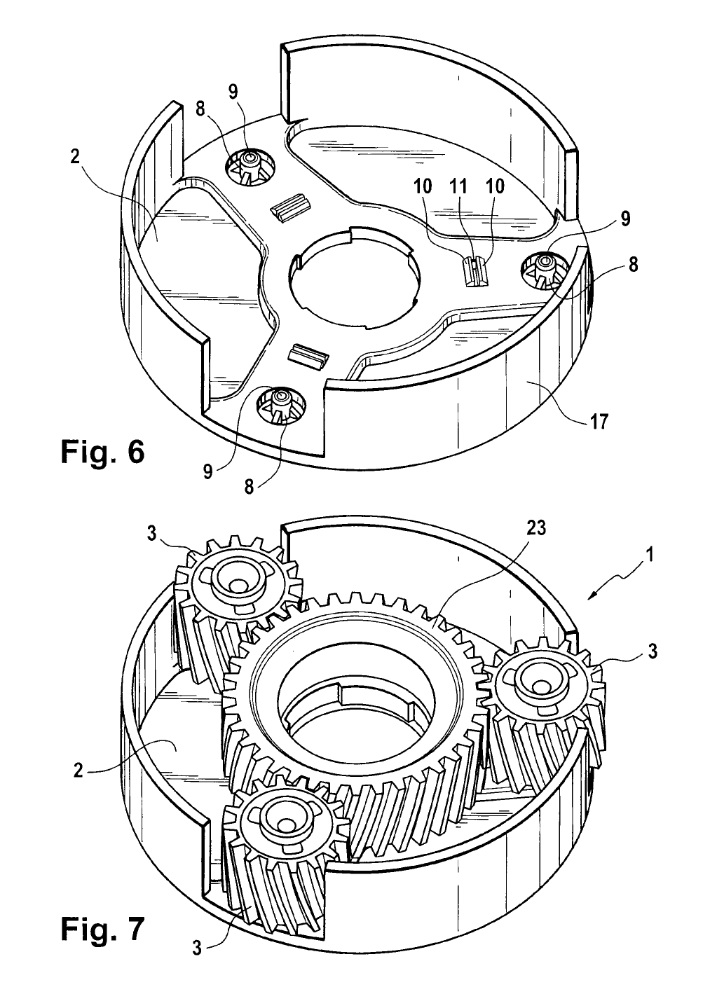

The planet carrier 1 with attached lubricant channels 7 is to be seen in FIG. 5 from above and in FIG. 6 from below. FIG. 7 shows how the planet carrier 1 looks after placement of the planet gears 3 and also after the planet gears 3 mesh with the sun wheel 23.

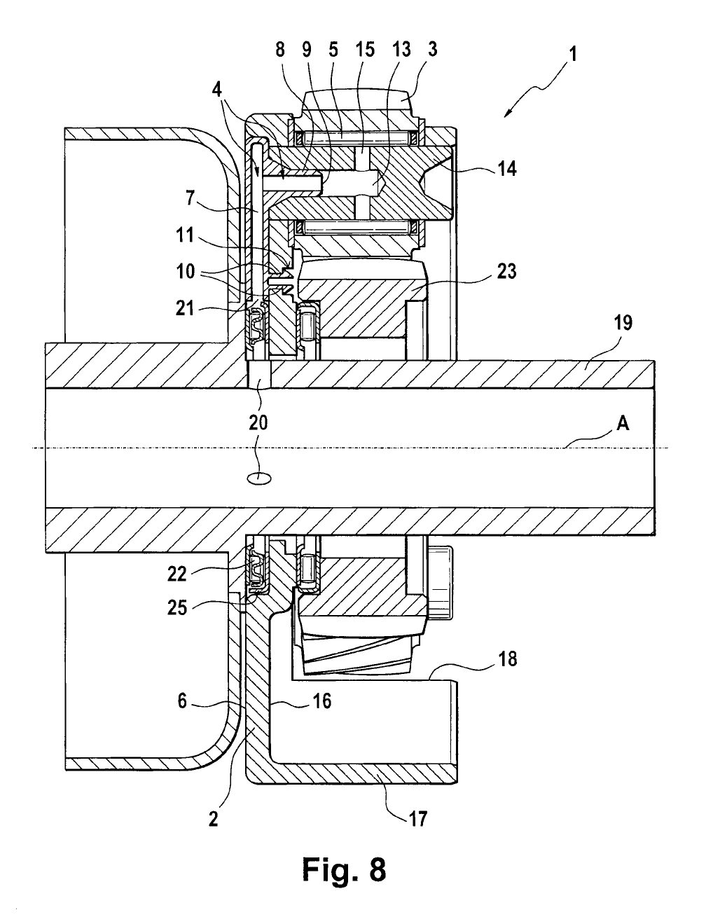

Additional structural details of the proposed solution emerge from FIG. 8, which, however, are in no way necessary.

The planet carrier 1 is arranged concentric to a hollow shaft 19, through whose interior lubricating oil can be guided. The lubricating oil emerges radially through radial bores 20 (three of these are arranged equidistant around the periphery of the shaft 19) outwards into the hollow shaft 19. The outlet point of the oil from the radial bores 20 lies adjacent to the inlets 21 (see FIG. 4) of the lubricant channels 7.

In the present case, an axial bearing 22, which is shown only very schematically in FIG. 8, is arranged between the radially outer ends of the radial bores 20 and the inlets 21 of the lubricant channels 7. In this area, there is also an angle disk 25, which has openings at the necessary points for the purpose of allowing oil to pass.

The oil fed via the hollow shafts 19 flows in the operation of the planetary gear via the axial bearing 22 into the lubricant channels 7 radially outwardly and is deflected into the other channel section 8, where it emerges at the outlet 9. Here, there is an axle 14, which carries a planet gear 3. The axle 14 is equipped with a blind bore 13, which is penetrated, in turn, by a cross bore 15. Thus, the oil is led to the bearing 5, with which the planet gear 3 is supported on the axle 14. In the present case, the bearing 5 is formed as a needle ring, as is typical in the application case in question.

As shown, the lubricant channel 7 is arranged on one side 6 of the disk-shaped section 2, while the oil emerges from the outlet 9 of the other channel section 8 on the other side 16 of the disk-shaped section 2, also like the individual planet gears 3.

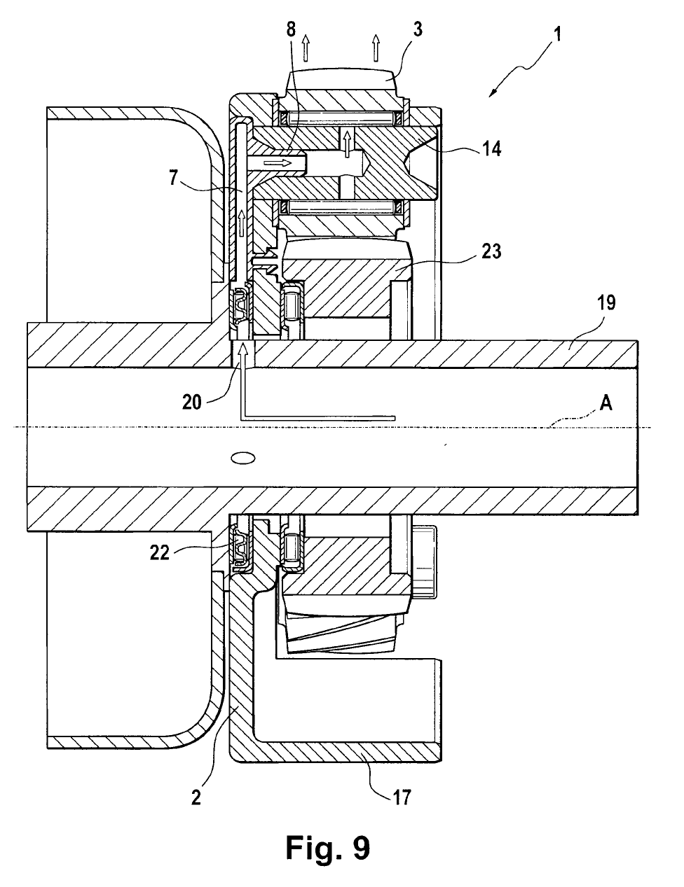

In FIG. 9, the resulting oil flow is illustrated again and indicated with arrows.

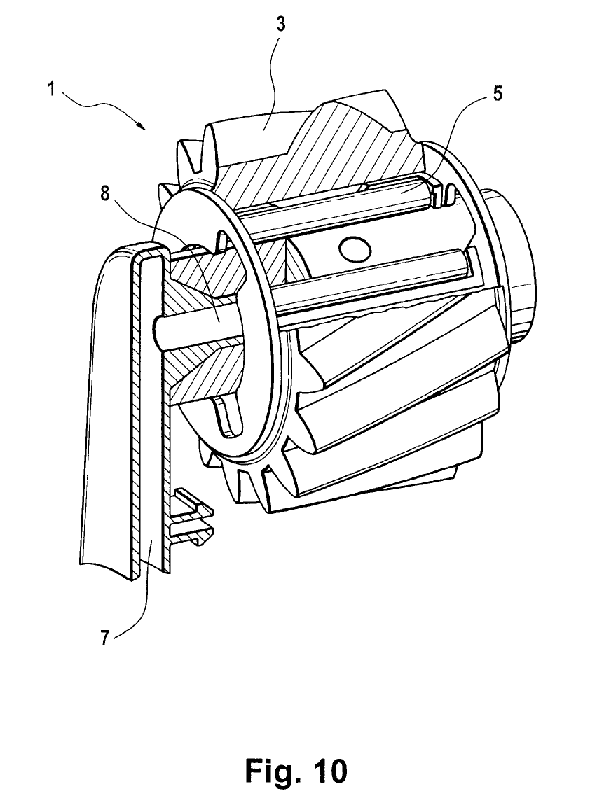

FIG. 10 shows how the interior of the lubricant channel 7 looks, as well as its transition to the other channel section 8. There it is to be further seen how the planet gear 3 is supported by the bearing 5 on the axle, which is not shown in more detail.

In the present case, the planet carrier 1 is configured as a pot-shaped carrier formed from drawn sheet metal, with the shown contours being produced by means of stamping, pressing, or deep drawing. However, in exactly this way, the realization as a disk planet carrier is also possible. The impressed recesses 12 are used not only for the improved reception of the lubricant channel 7 and for preventing disruptive edges, but also for reinforcing the component.

The oil outlet in the area of the planet gears 3—after the lubrication of the bearing 5 or the planet gears 3—can be influenced by axial thrust disks, so-called bearing disks.

### LIST OF REFERENCE SYMBOLS

1 Planet carrier
2 Disk-shaped section
3 Planet gear
4 Means for supplying lubricant
5 Bearing of planet gears
6 Side of the disk-shaped section
7 Lubricant channel
8 Additional channel section
9 Outlet
10 Catch or clip connection
11 Catch or clip connection
12 Recess
13 Bore (blind bore)
14 Axle
15 Cross bore
16 Side of the disk-shaped section
17 Reinforcement element
18 Break
19 Shaft
20 Radial bore
21 Inlet of lubricant channel
22 Axial bearing
23 Sun wheel
24 Bore
25 Angle disk
A Axle direction

1. Planet carrier (1) for a planetary drive, adapted for use in a motor vehicle transmission, comprising a disk-shaped section (2), over whose periphery a number of planet gears (3) are supported, and a lubricating device (4) on the disk-shaped section to supply an area of the planet gears (3) and/or a bearing (5) thereof with lubricant, the lubricating device (4) includes at least one lubricant channel (7) extending radially on one side (6) of the disk-shaped section (2).

2. Planet carrier according to claim 1, wherein the lubricant channel (7) is in fluid connection with another channel section (8), which expands over a given extent in an axial direction (A) of the planet carrier (1) up to an outlet (9) for the lubricant.

3. Planet carrier according to claim 1, wherein the disk-shaped section (2) and the at least one lubricant channel (7) are manufactured separately and then connected to each other.

4. Planet carrier according to claim 3, wherein the disk-shaped section (2) is made from metal and the lubricant channel (7) is made from plastic.

5. Planet carrier according to claim 3, wherein the disk-shaped section (2) and the at least one lubricant channel (7) are connected to each other by a catch or clip connection (10, 11).

6. Planet carrier according to claim 3, wherein the disk-shaped section (2) has at least one recess (12) corresponding to a contact surface of the lubricant channel (7) on the disk-shaped section (2).

7. Planet carrier according to claim 2, wherein the lubricant channel (7) is formed as a channel with a generally rectangular cross section and that the other channel section (8) is formed as a generally cylindrical channel.

8. Planet carrier according to claim 7, wherein the other channel section (8) extends concentric to an axle of a respective one of the planet gears (3).

9. Planet carrier according to claim 8, the outlet (9) of the other channel section (8) opens into a bore (13) of an axle (14) which carries the respective one of the planet gears (3) via the bearing (5).

10. Planet carrier according to claim 9, wherein the axle (14) has a cross bore (15).

11. Planet carrier according to claim 9, wherein the at least one lubricant channel (7) comprises a plurality of the channels (7) that are arranged on the one side (6) of the disk-shaped section (2) opposite a side (16), on which the axle (14) is arranged.

12. Planet carrier according to claim 1, wherein the bearing (5) is formed as a needle ring bearing.

13. Planet carrier according to claim 1, wherein a reinforcement element (17), extending in the axle direction (A), is connected to the disk-shaped section (2) of the planet carrier (1) in a radially outer area.

14. Planet carrier according to claim 13, wherein the reinforcement element (17) is formed as a ring element.

15. Planet carrier according to claim 14, wherein the ring element (17) has a number of breaks (18) over a periphery thereof.

16. Planet carrier according to claim 15, wherein the number of breaks (18) corresponds to a number of the planet gears (3) carried by the planet carrier (1).

17. Planet carrier according to claim 13, wherein the disk-shaped section (2) including the reinforcement element (17) is formed as a shaped sheet-metal part.

18. Planet carrier according to claim 1, wherein the planet carrier is carried by a shaft (19), which is formed as a hollow shaft and which has radial bores (20) for the passage of lubricant.

19. Planet carrier according to claim 18, wherein a radial bore (20) is adjacent to an inlet (21) of the lubricant channel (7).

20. Planet carrier according to claim 19, wherein an axial bearing (22) is arranged between the radial bore (20) and the inlet (21) of the lubricant channel (7).

21. Planet carrier according to claim 1, wherein there are three of the planet gears (3) arranged around a periphery of the disk-shaped section (2).
